(19) United States
(12) Patent Application Publication
(10) Pub. No.: US 2016/0137103 A1
(43) Pub. Date: May 19, 2016

(54) CONSOLE FOR A VEHICLE SEAT, METHOD FOR PRODUCING A CONSOLE, AND VEHICLE SEAT

(71) Applicant: JOHNSON CONTROLS COMPONENTS GMBH & CO. KG, Kaiserslautern (DE)

(72) Inventors: Herbert LAHAYE, Martinshöhe (DE); Eckhard SPIES, Enkenbach-Alsenborn (DE)

(21) Appl. No.: 14/901,187

(22) PCT Filed: Jun. 26, 2014
(86) PCT No.: PCT/EP2014/063616

§ 371 Date: Dec. 28, 2015

(30) Foreign Application Priority Data
Jun. 28, 2013 (DE) 10 2013 212 569.0

(51) Int. Cl. B60N 2/005; B62D 65/14

(52) U.S. Cl. CPC B60N 2/005; B62D 65/14

(57) ABSTRACT

A console (101, 201), for a vehicle seat (1), includes a console body (103, 203), which can be connected to the vehicle seat (1). The console (101, 201) includes at least one bottom plate (24), which is connected to the console body (103, 203) and which can be connected to a vehicle floor. A method for producing the console (101, 201), includes connecting the console body (103, 203), which can be connected to the vehicle seat (1), to the bottom plate (24), which can be connected to a vehicle floor. The invention further relates to the vehicle seat (1), which comprises at least one console (101, 201).

### CROSS REFERENCE TO RELATED APPLICATIONS

This application is a United States National Phase Application of International Application PCT/EP2014/063616 filed Jun. 26, 2014 and claims the benefit of priority under 35 U.S.C. §119 of German Patent Application 10 2013 212 569.0 filed Jun. 28, 2013 the entire contents of which are incorporated herein by reference.

### FIELD OF THE INVENTION

The invention relates to a console for a vehicle seat, in particular for a commercial-vehicle seat, having a console body, which can be connected to the vehicle seat, and to a method for producing a console. The invention also relates to a vehicle seat, in particular a commercial-vehicle seat, having at least one console.

### BACKGROUND OF THE INVENTION

Commercial-vehicle seats, in particular for the retrofit market, are installed in a variety of vehicles. In order to adapt a commercial-vehicle seat to a certain type of vehicle, use is made in each case of a specific console, which is connected, in particular screwed or riveted, to the floor of the vehicle and to the commercial-vehicle seat. A preliminary adjustment of the seat height, that is to say of the distance of the seat surface, or of a lower frame of the vehicle seat, from the vehicle floor, is carried out by way of the console at the same time.

Different types of vehicle usually have different fastening points for fastening the console on the vehicle floor. This means that each type of vehicle in which a commercial-vehicle seat is to be installed requires a separate console, adapted specifically to this type of vehicle.

### SUMMARY OF THE INVENTION

It is an object of the invention to provide a console of the type mentioned in the introduction, which can be adapted to a plurality of different types of vehicle.

A vehicle-seat console of the type in question comprises a console body, which can be connected to the vehicle seat.

According to the invention, the console comprises at least one floor panel, which is connected to the console body and can be connected to a vehicle floor.

For adaptation to different types of vehicle, all that is required is for the floor panel to be configured correspondingly. The console itself is adapted to the vehicle seat and independent of the vehicle.

The console body here is preferably screwed to the floor panel. Other fastening methods, for example welding, are also conceivable.

The floor panel advantageously has holes, of which the positions are adapted to hole patterns of different vehicle floors. This makes it comparatively straightforward to adapt to different types of vehicle by selecting the appropriate holes. The console is thus of modular construction. It is possible for different console bodies, which differ for example in terms of their extent in the vertical direction, to be connected to the same floor panel to form a console.

The console body is preferably of cuboidal configuration.

According to an advantageous configuration of the invention, the console body is produced from a panel which constitutes a projected development of the console body.

The panel here has a base surface, two cover surfaces, two stiffening surfaces, a front surface, a rear surface, two side surfaces and a plurality of tabs for welding to the front surface and the rear surface.

It is advantageous for the stiffening surfaces, following production of the console body, to be angled through approximately 45° relative to the cover surfaces and to project into the interior of the console body. This advantageously increases the strength of the console body.

The object is also achieved by a method for producing a console having the features according to the invention. According to the method aspect of the invention, a console body, which can be connected to a vehicle seat, is connected to a floor panel, which can be connected to a vehicle floor.

The console body here is preferably screwed to a floor panel. Other fastening methods, for example welding, are also conceivable.

The console body is advantageously produced from a panel which constitutes a projected development of the console body. The panel here is cut out of a basic metal sheet, and the panel is folded along predetermined lines and then welded so as to form the console body.

The panel advantageously has tabs for welding purposes.

The panel is preferably cut out by means of laser trimming, and this allows the desired shape to be followed precisely.

The object is also achieved by a vehicle seat which has a console according to the invention.

The vehicle seat preferably comprises a scissor-action framework, by means of which it is possible to adjust the height of a seat part of the vehicle seat above the console.

The vehicle seat preferably comprises a rotating device, by means of which a seat part of the vehicle seat can be rotated relative to the console.

The invention will be explained in more detail hereinbelow with reference to two advantageous exemplary embodiments illustrated in the figures. The invention is nevertheless not limited to these exemplary embodiments. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic illustration of a vehicle seat according to a first exemplary embodiment;

FIG. 2 is a plan view of a floor panel;

FIG. 3 is a side view of the vehicle seat according to the first exemplary embodiment;

FIG. 4 is a side view of a vehicle seat according to the second exemplary embodiment;

FIG. 5 is a view showing a panel for producing a console body according to the first exemplary embodiment;

FIG. 6 is a view showing a panel for producing a console body according to the second exemplary embodiment;

FIG. 7 is a perspective view of a console according to the first exemplary embodiment; and

FIG. 8 is a perspective view of a console according to the second exemplary embodiment.

### DESCRIPTION OF THE PREFERRED EMBODIMENTS

A vehicle seat 1 for a commercial vehicle has a scissor-action framework 3 which is intended for height-adjustment purposes and comprises a lower frame 5, an upper frame 7, which is arranged above the lower frame, and a pair of crossed-over rockers 8a and 8b on either side. A transverse tube 10 connects the two crossover points and, at the same time, defines the scissor axis, about which the rockers 8a and 8b can pivot relative to one another.

The arrangement of the vehicle seat 1 within a commercial-vehicle cab and the customary direction of travel of the commercial vehicle define the directional information used hereinbelow. A direction which is oriented perpendicularly to the floor of the commercial-vehicle cab will be referred to hereinbelow as the vertical direction, and a direction perpendicular to the vertical direction, and perpendicular to the direction of travel, will be referred to hereinbelow as the transverse direction.

The rockers 8a and 8b are articulated, at their rear end in each case, on the lower frame 5 and on the upper frame 7 and each have, at their front end, rotatable rollers, by means of which they are guided in or on the upper frame 7 and/or lower frame 5 for movement in the longitudinal direction of the seat. This movement of the rockers 8a and 8b changes the height of the upper frame 7 above the lower frame 5, referred to hereinbelow for short as the height of the scissor-action framework 3. A gas spring 12 and preferably a damper render the scissor-action framework 3 into a system which is capable of oscillating movement, and this considerably increases the seat comfort.

The two pairs of crossed-over rockers 8a and 8b each comprise a first rocker 8a, which is arranged on the outside, and a second rocker 8b, which is arranged on the inside. The two first rockers 8a are fixed to one another at their one, lower end, in the present case the front end, by means of a bearing tube 18, which at the same time bears the rollers. The two second rockers 8b are fixed to one another by means of the transverse tube 10. Furthermore, the other ends of the corresponding rockers 8a or 8b are fixed to one another by means of further tubes.

The vehicle seat 1 also has a seat frame 16, which on the one hand, in its rear region, is articulated on the upper frame 7 on either side and on the other hand, in its front region, can be raised and lowered by means of an inclination adjuster and can thus be adjusted in respect of its inclination relative to the scissor-action framework 3. The vehicle seat 1 additionally has a backrest 17, which is fitted on the seat frame 16 in the present case such that it can be adjusted in terms of inclination. As an alternative, the backrest 17 may also be fitted on the upper frame 7. The backrest 17 and the seat frame 16, which comprises a seat cushion, form a seat part 20.

The seat part 20, together with the scissor-action framework 3, can be displaced by means of a pair of rails 15, as a result of which the vehicle seat 1 can be adjusted in a translatory manner. The pair of rails 15 comprises two seat rails, which are arranged parallel in a first plane and of which each has a lower rail and an upper rail, which can be moved relative to the lower rail.

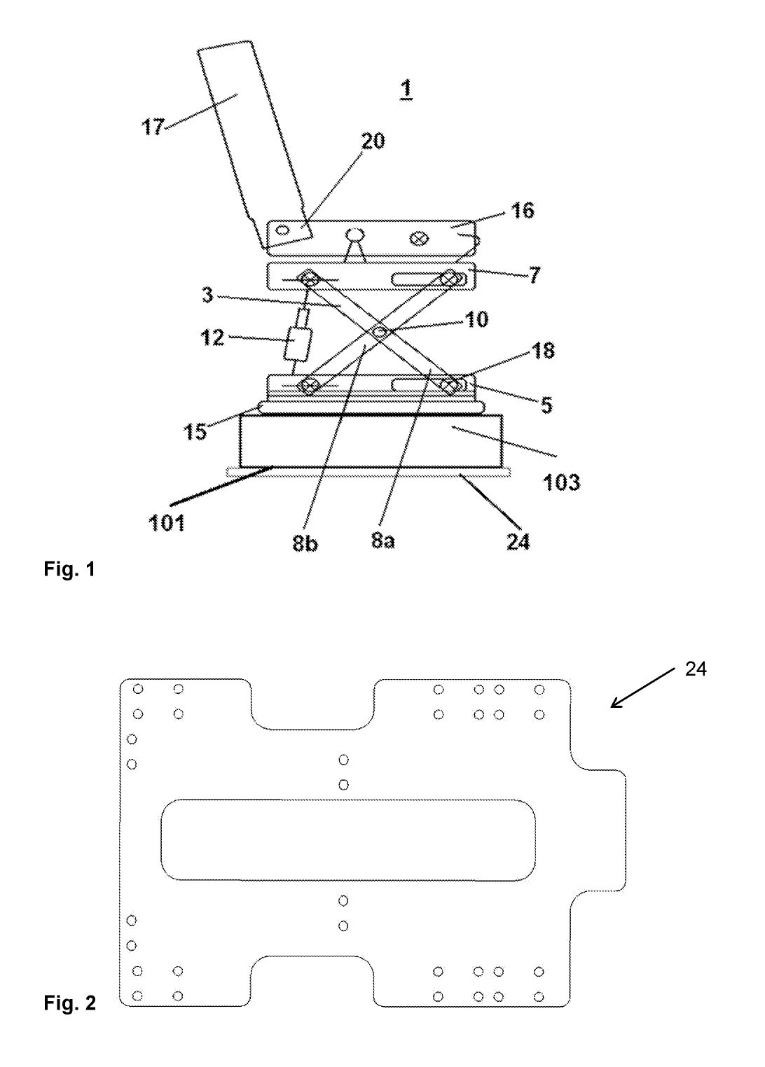

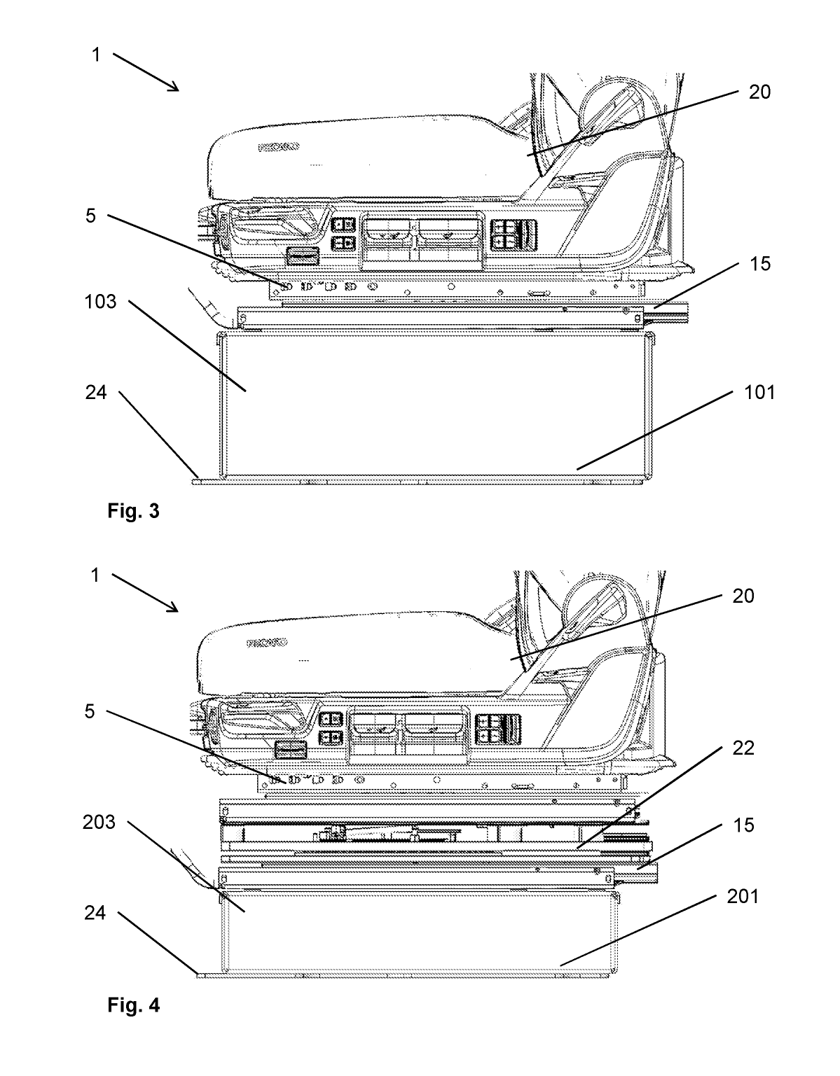

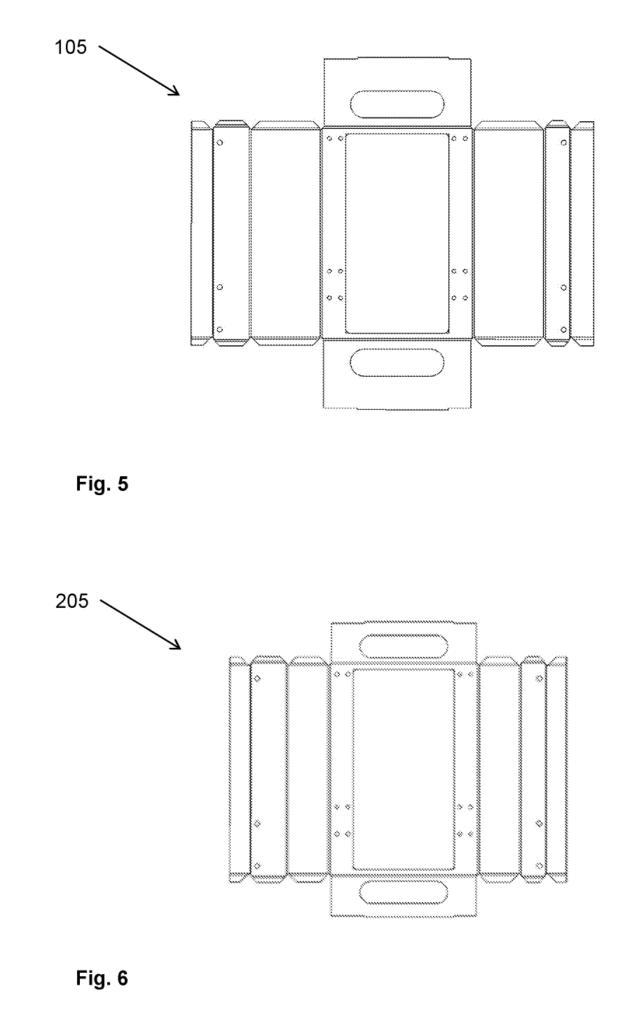

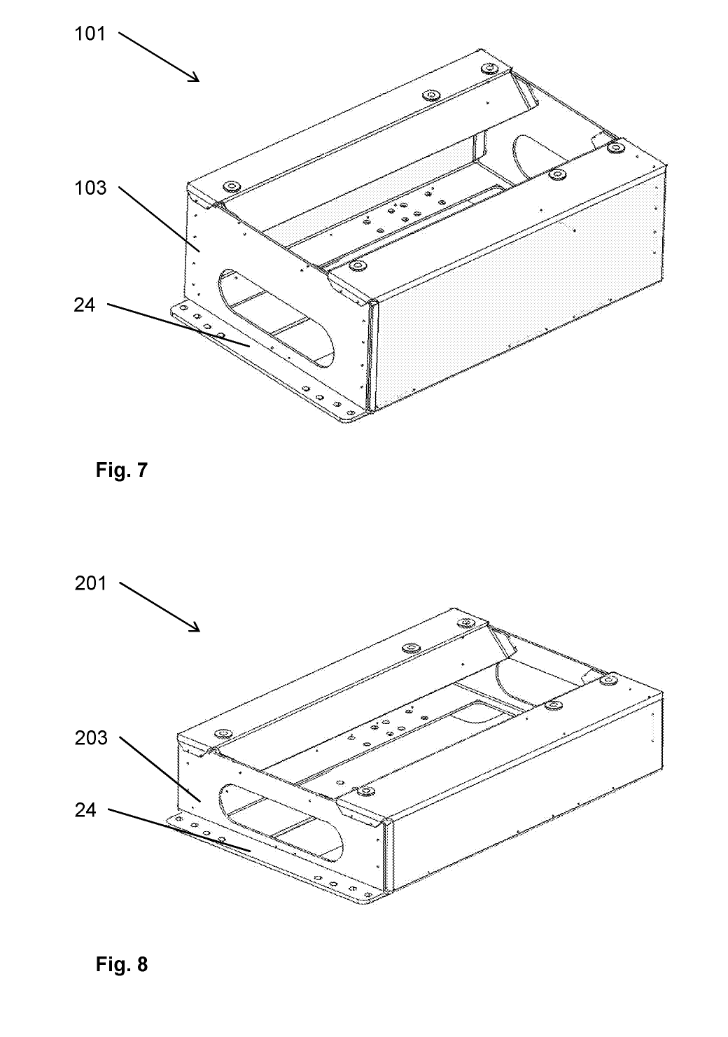

According to a first exemplary embodiment, which is illustrated in FIGS. 1 and 3, the lower frame 5 of the vehicle seat 1 is connected directly to the upper rails of the pair of rails 15.

The lower rails of the pair of rails 15 are connected, in the present case screwed, to a console 101. The console 101, for its part, is connected, in the present case screwed, to the floor of the commercial-vehicle cab.

The console 101 comprises a console body 103, which is connected to the lower rails of the pair of rails 15, and a floor panel 24, which is connected to the floor of the commercial-vehicle cab. The console body 103 and the floor panel 24 are likewise connected, in the present case screwed, to one another.

For production of the console 101, first of all a panel 105, which constitutes a projected development of the console body 103, is cut out of a basic metal sheet by means of laser trimming.

The panel 105 comprises a base surface 60, two cover surfaces 70 and two stiffening surfaces 80. The panel 105 also comprises a front surface 110, a rear surface 120 and two side surfaces 130, which butt against the base surface 60. The panel 105 has tabs 50, which each project laterally from the side surfaces 130, the cover surfaces 70 and the stiffening surfaces 80.

Bores for fastening the lower rails of the pair of rails 15 are made in the cover surfaces 70 of the panel 105. Bores for fastening the floor panel 24 are made in the base surface 60 of the panel 105.

Thereafter, the panel 105 is folded along predetermined lines between the individual surfaces 60, 70, 80, 110, 120, 130 and between the surfaces 70, 80, 130 and the tabs 50, and the tabs 50 are welded to the front surface 110 and the rear surface 120. The resulting console body 103, which is of cuboidal configuration, is then screwed to the floor panel 24.

The stiffening surfaces 80 of the console body 103 here are angled through approximately 45° relative to the cover surfaces 70 and project into the interior of the console body 103.

According to a second exemplary embodiment, which is illustrated in FIG. 4, the vehicle seat 1 comprises a rotating device 22. The rotating device 22 comprises an upper plate, on which the lower frame 5 of the vehicle seat 1 is fastened, and a lower plate, which is connected to the upper rails of the pair of rails 15. The upper plate and the lower plate are mounted such that they can be rotated relative to one another about a vertically running axis of rotation, and they can be fixed in a set rotary position by means of a securing device. The rotating device 22 allows the seat part 20 of the vehicle seat 1 to be rotated relative to the commercial-vehicle cab about the vertically running axis of rotation.

The lower rails of the pair of rails 15 are connected, in the present case screwed, to a console 201. The console 201, for its part, is connected, in the present case screwed, to the floor of the commercial-vehicle cab.

The console 201 comprises a console body 203, which is connected to the lower rails of the pair of rails 15, and a floor panel 24, which is connected to the floor of the commercial-vehicle cab. The console body 203 and the floor panel 24 are likewise connected, in the present case screwed, to one another.

For production of the console 201, first of all a panel 205, which constitutes a projected development of the console body 203, is cut out of a basic metal sheet by means of laser trimming

The panel 205 comprises a base surface 60, two cover surfaces 70 and two stiffening surfaces 80. The panel 205 also comprises a front surface 210, a rear surface 220 and two side surfaces 230, which butt against the base surface 60. The panel 205 has tabs 50, which each project laterally from the side surfaces 230, the cover surfaces 70 and the stiffening surfaces 80.

Bores for fastening the lower rails of the pair of rails 15 are made in the cover surfaces 70 of the panel 205. Bores for fastening the floor panel 24 are made in the base surface 60 of the panel 205.

Thereafter, the panel 205 is folded along predetermined lines between the individual surfaces 60, 70, 80, 210, 220, 230 and between the surfaces 70, 80, 230 and the tabs 50, and the tabs 50 are welded to the front surface 210 and the rear surface 220. The resulting console body 203, which is of cuboidal configuration, is then screwed to the floor panel 24.

The stiffening surfaces 80 of the console body 203 here are angled through approximately 45° relative to the cover surfaces 70 and project into the interior of the console body 203.

The console 101 and the console 201 differ here merely in terms of their height, that is to say their extent in the vertical direction. The console 101 and the console 201 each have the same type of floor panel 24, but different console bodies 103, 203. The console body 103 and the console body 203 here differ merely in terms of their height, that is to say their extent in the vertical direction. The extent of the console body 203 in the vertical direction is smaller than the extent of the console body 103 in the vertical direction.

The different extents of the console bodies 103, 203 in the vertical direction result from different configurations of the aforementioned panels 105, 205. The panel 105 and the panel 205 here are of similar configuration, but the front surfaces 110, 210, the rear surfaces 120, 220 and the side surfaces 130, 230, which extend vertically following the folding operation described, are different. The front surface 110, the rear surface 120 and the side surfaces 130 of the panel 105 extend further away from the base surface 60 than the front surface 210, the rear surface 220 and the side surfaces 230 of the panel 205.

The rest of the surfaces 60, 70, 80 of the panels 105, 205 are the same. The bores in the cover surfaces 70 for fastening the lower rails of the pair of rails 15 and the bores in the base surface 60 for fastening the floor panel 24 are made at the same locations.

The floor panel 24 comprises bores for fastening a console body 103, 203. The same bores serve here for fastening a console body 103 and for fastening a console body 203.

The floor panel 24 also comprises holes 28 for fastening on the floor of a commercial-vehicle cab. For this purpose, the floor panel 24 has a plurality of bores and/or slots, which are adapted to hole patterns of different commercial-vehicle cabs. For fastening the console 101, 201 on the commercial-vehicle cab, use is therefore made merely of those holes which correspond to the hole pattern of the relevant commercial-vehicle cab.

The features disclosed in the above description, the claims and the drawings may be important both individually and in combination for the purpose of realizing the various configurations of the invention.

While specific embodiments of the invention have been shown and described in detail to illustrate the application of the principles of the invention, it will be understood that the invention may be embodied otherwise without departing from such principles.

1. A console for a vehicle seat, the console comprising:
a console body, which can be connected to the vehicle seat; and
at least one floor panel connected to the console body and connectable to a vehicle floor.

2. The console as claimed in claim 1, wherein the console body is screwed to the floor panel.

3. The console as claimed in claim 1, wherein the floor panel has holes defining hole positions that are adapted to hole patterns of different vehicle floors.

4. The console as claimed in claim 1, wherein the console body is of cuboidal configuration.

5. The console as claimed in claim 1, wherein the console body is produced from a panel which constitutes a projected development of the console body.

6. The console as claimed in claim 5, wherein the panel comprises a base surface, two cover surfaces, two stiffening surfaces, a front surface, a rear surface, two side surfaces and tabs.

7. The console as claimed in claim 6, wherein the stiffening surfaces, following production of the console body, are angled through approximately 45° relative to the cover surfaces and project into the interior of the console body.

8. A method for producing a console, the method comprising the steps of:
providing a console body, which can be connected to a vehicle seat;
providing a floor panel, which can be connected to a vehicle floor;
connecting the console body to the floor panel.

9. The method as claimed in claim 8, wherein the console body is screwed to the floor panel for connecting the console body to the floor panel.

10. The method as claimed in claim 9, wherein the console body is produced from a panel which constitutes a projected development of the console body, wherein the panel is cut out of a basic metal sheet, and the panel is folded along predetermined lines and then welded so as to form the console body.

11. The method as claimed in claim 10, wherein the panel has tabs defining welding locations for welding purposes.

12. The method as claimed in claim 11, wherein the panel is cut out by means of laser trimming.

13. A vehicle seat comprising at least one console comprising:
a console body, which can be connected to the vehicle seat; and
at least one floor panel connected to the console body and connectable to a vehicle floor.

14. The vehicle seat as claimed in claim 13, further comprising a scissor-action framework, by means of which it is possible to adjust the height of a seat part of the vehicle seat above the console.

15. The vehicle seat as claimed in claim 14, further comprising a rotating device, by means of which a seat part of the vehicle seat can be rotated relative to the console.
